(19) United States
(12) Patent Application Publication
(10) Pub. No.: US 2019/0223522 A1
(43) Pub. Date: Jul. 25, 2019

(54) COMPOSITE MATERIAL FOR GARMENT, GARMENT FABRICATED WITH COMPOSITE MATERIAL, AND MANUFACTURING METHODS THEREOF

(71) Applicants: JOBANY CANO, BELLEVILLE, NJ (US); PAUL ZAIDMAN, LIMA (PE)

(72) Inventors: JOBANY CANO, BELLEVILLE, NJ (US); PAUL ZAIDMAN, LIMA (PE)

(21) Appl. No.: 16/253,502

(22) Filed: Jan. 22, 2019

Related U.S. Application Data
(60) Provisional application No. 62/620,511, filed on Jan. 23, 2018.

(51) Int. Cl. A41D 1/22; A41D 27/02; A41D 1/06; A41D 1/14; A41C 1/00; C09D 175/04

(52) U.S. Cl. CPC A41D 1/22; A41D 27/02; A41D 1/06; A41D 2400/38; A41C 1/00; C09D 175/04; A41D 1/14

(57) ABSTRACT

A composite material for garments, such as shapewear and sportswear garments, is formed of an outer layer that is highly elastic with high compression and an inner layer provided on the outer layer and made of a material that is elastic, waterproof and oil proof. The outer layer is a fabric base fabricated from a blend of polyester and spandex. The inner layer comprises a coating of polyurethane (PU) containing nano-titanium dioxide (nano-TiO₂). When used to fabricate a garment, the inner layer of the composite material is adjacent to the body of the wearer when the garment is worn such that perspiration from the wearer's skin and/or skin contact products, such as oil/water based body creams and gels, applied to the wearer's skin are not absorbed by the inner layer and are thereby prevented by the inner layer from being transmitted to the fabric base.

### RELATED APPLICATION

This application claims priority from U.S. provisional patent application No. 62/620,511, filed Jan. 23, 2018, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### TECHNICAL FIELD

The present invention relates generally to garments, and more particularly, to a composite material for garments. The present invention also relates to garments made of the composite material and to manufacturing methods thereof.

### BACKGROUND

Compression or shaping garments are used to provide support and improve the appearance of the wearer. Better known today as shapers, these shaping garments include body suits, girdles and corsets. However, while providing a body shaping function, these shapers do not directly contribute to the user's actual weight loss or other daily fitness purpose. For example, these shapers cannot be used in combination with gel/oil/water based creams and other skin contact products which are applied directly to and absorbed by the user's skin for various purposes, including weight-loss, cellulite-elimination, moisturization and skin detoxification. In addition to staining the fabric materials forming the shapers, such skin contact products would be absorbed by the fabric materials, thereby reducing the amount of the skin contact product to be absorbed by the user's body.

Body wraps have been widely used for body heat conservation, increasing core temperature to induce more sweat and serving as a media to insulate oil/water based creams and other skin contact products between the user's skin and a garment worn by the user. However, such body wraps are very expensive and complicated to put on, can only be used once, and are required to be hidden under the garment due to their unattractive construction and design.

Conventional shaping garments configured to apply compression are also very difficult to apply and in many instances generate marks on the wearer's skin which last for a long time. While some conventional shaping garments are easy to put on and take off, they fail to apply sufficient compression to the wearer's body to achieve significant changes to the form of the wearer's body and, therefore, are unable to produce a more fashionable slim figure and to significantly enhance the natural curves of the wearer's body.

Therefore, it is desirable to provide garments, and particularly shapewear garments, which can be used in combination with gel/oil/water based creams and other skin contact products applied directly to the user's skin, which are easy to apply, and which are effective in enhancing the natural curves of the wearer's body while maintaining long-term comfort.

### SUMMARY

In a first aspect, the present invention is directed to a composite material for garments, such as sportswear and shapewear garments. The composite material comprises an outer layer that is highly elastic with high compression, and an inner layer provided on the outer layer and made of a material that is elastic, waterproof and oil proof. The inner layer is elastic and impervious to water and to oil/water based body creams and gels and similar products.

When the composite material is incorporated in a garment that is worn by a user, the inner layer is adjacent the user's body so that perspiration (sweat) from the user's skin and/or skin contact products, such as oil/water based body creams and gels, applied to the users skin are not absorbed by the inner layer and are thereby prevented by the inner layer from being transmitted to the outer layer. The inner layer therefore constitutes means for isolating skin perspiration and skin products in contact with the user's skin from the outer layer.

In one embodiment of the composite material, the outer layer is a fabric base fabricated from a blend of polyester and spandex, and the inner layer comprises a coating of polyurethane (PU) containing nano-titanium dioxide (nano-TiO₂). In one particular example of this embodiment, the outer layer is a material fabricated from a blend of about 90% to 99% polyester and about 1% to 10% spandex, and the inner layer contains about 99% to 99.9% PU and about 0.1% to 1% nano-TiO₂.

The coating of PU and and nano-TiO₂ can be applied to the fabric base utilizing any technique known in the art. For example, the coating can be applied to the fabric base utilizing known dip coating or spray coating techniques.

In another embodiment, when the composite material according to the present invention is incorporated in a garment, different levels of compression can be achieved by adjusting the compression of the outer layer to serve different compression needs of different body parts of the wearer, including the abdomen, waist, back and/or breasts.

In a second aspect, the present invention is directed to garments, such as sportswear and shapewear garments, using the composite material according to the foregoing first aspect and corresponding embodiments.

In one embodiment of the second aspect, the garment is a shapewear garment formed of a plurality of panels connected together and configured to provide targeted levels of compression and elasticity to firm up various parts of the wearer's body, such as to flatten the abdomen, cinch the waist, create a smoother and tighter backline, and/or provide women's breasts with firm and comfortable support. As one example, each of the panels configured to provide targeted levels of compression and elasticity to the abdomen, waist and back of the user is formed of the composite material described above with respect to the first aspect, and the panel(s) configured to provide a user's breasts with firm and comfortable support is formed of a fabric material fabricated from a blend of about 90% to 99% polyester and about 1% to 10% spandex. In another embodiment, the garments employing the composite material according to the present invention does not contain the plurality of panels described above.

When worn by a user, the arrangement and construction of the shapewear garment formed of the composite material according to the present invention creates a well-sealed space around the user's torso forming a microenvironment between the shapewear garment and the user's body that induces perspiration. The microenvironment captures body heat and slows down the heat vitalization, thereby inducing the user's body to sweat more. Specifically, the shapewear garment conserves body heat by sealing the body heat in and increases the core temperature, thereby making the user sweat more while performing physical activity, such as during a workout.

In a third aspect, the present invention is directed to manufacturing methods for the composite material and garments according to the foregoing first and second aspects and corresponding embodiments.

### BRIEF DESCRIPTION OF THE DRAWINGS

The foregoing summary, as well as the following detailed description of preferred embodiments of the invention, will be better understood when read in conjunction with the accompanying drawings. For the purpose of illustrating the invention, there is shown in the drawings embodiments which are presently preferred. It should be understood, however, that the invention is not limited to the precise arrangement and instrumentalities shown. In the drawings:

FIG. 1 is a cross-sectional view of a composite material for garments according to an exemplary embodiment of the present invention;

FIGS. 2A-2B are front (FIG. 2A) and rear (FIG. 2B) views of an exemplary embodiment of a shapewear garment, generally designated at 13, for women employing the composite material according to the present invention, the shapewear garment being applied on a mannequin 14 to illustrate the shapewear garment in use with respect to the wearer's body.

FIGS. 3A-3D are additional front (FIG. 3A), rear (FIG. 3B) and perspective (FIGS. 3C-3D) views of the exemplary garment for women according to the present invention applied on a mannequin to illustrate the garment in use with respect to the wearer's body.

FIGS. 4A-4B are views similar to FIGS. 3A-3B, respectively, except that the garment in FIGS. 4A-4B is applied on the mannequin in an inverted state to illustrate the inner layer of the composite material forming the garment.

FIG. 5 is a plan view of the separate pieces forming the shapewear garment shown in FIGS. 2A-4B and illustrating the design or pattern thereof

FIGS. 6A-6C are rear (FIG. 6A), front (FIG. 6B) and perspective (FIG. 6C) views of another exemplary shapewear garment employing the composite material according to the present invention, the shapewear garment being designed for use by men.

FIGS. 7A-7C are views of the shapewear garment for men similar to FIGS. 6A-6C, except that the shapewear garment is applied on the wearer in an inverted state (i.e., the inside of the garment is shown on the outside) to illustrate the inner layer of the composite material forming the garment.

FIG. 8 is a plan view of the separate pieces forming the shapewear garment shown in FIGS. 6A-7C and illustrating the design or pattern thereof

FIGS. 9A-9B are front and rear views of an exemplary embodiment of another shapewear garment, generally designated at 30, employing the composite material according to the present invention, the garment being applied on a mannequin 14 to illustrate the garment in use with respect to the wearer's body.

FIGS. 10A-10B are rear and front views of an exemplary embodiment of another shapewear garment, generally designated at 40, employing the composite material according to the present invention, the garment being applied on a mannequin 14 to illustrate the garment in use with respect to the wearer's body.

FIGS. 11A-11B are front and rear views of an exemplary embodiment of another shapewear garment, generally designated at 50, employing the composite material according to the present invention, the garment being applied on a mannequin 14 to illustrate the garment in use with respect to the wearer's body.

FIGS. 12A-12B are rear and side perspective views of an exemplary embodiment of another shapewear garment, generally designated at 60, employing the composite material according to the present invention, the garment being applied on a mannequin 14 to illustrate the garment in use with respect to the wearer's body.

FIGS. 13A-13D are front, rear and side perspective views of an exemplary embodiment of another shapewear garment, generally designated at 70, employing the composite material according to the present invention, the garment being applied on a mannequin 14 to illustrate the garment in use with respect to the wearer's body. FIGS. 13C-13D further illustrate a portion of the garment being folded over to show inner layer 72 of the composite material.

### DETAILED DESCRIPTION

Embodiments of the various aspects of the present invention are best understood by reference to the detailed figures and description set forth herein. It will be readily appreciated by persons skilled in the art that the detailed description with reference to the drawings which follows is for explanatory purposes only as the invention extends beyond these described embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown,

It must be noted that as used herein and in the appended claims, the singular forms “a,” “an,” and “the” include the plural reference unless the context clearly dictates otherwise. Structures described herein are to be understood also to refer to functional equivalents of such structures. Language that may be construed to express approximation should be so understood unless the context clearly dictates otherwise.

In the disclosure of the various aspects and embodiments of the present invention, singular words should be read as plural and vice versa and masculine as feminine and vice versa, where appropriate, and alternative embodiments do not necessarily imply that the two are mutually exclusive.

For convenience of description, the terms “front”, “back”, “rear”, “bottom”, “right” and words of similar import will have reference to the various members and components of the composite material and garments of the present invention as arranged and illustrated in the figures of the drawings and described hereinafter in detail.

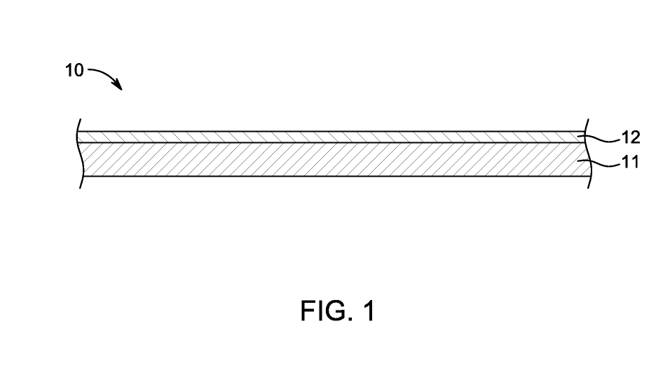

FIG. 1 is a cross-sectional view of a composite material for garments, such as sportswear and shapewear garments, according to an exemplary embodiment of a first aspect of the present invention. The composite material, generally designated at 10, is a double layer compound textile formed of an outer layer 11 as a fabric base that is highly elastic with high compression, and an inner layer 12 provided on the fabric base and made of a material that is elastic, waterproof and oil proof. Inner layer 12 is elastic and impervious to water and to oil/water based body creams and gels and similar products.

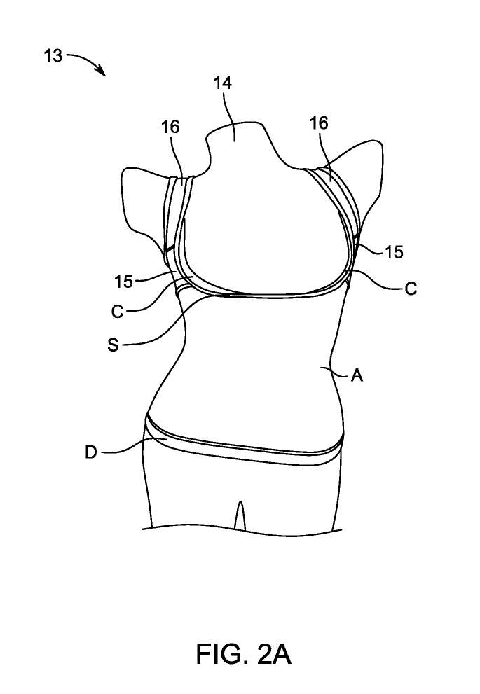

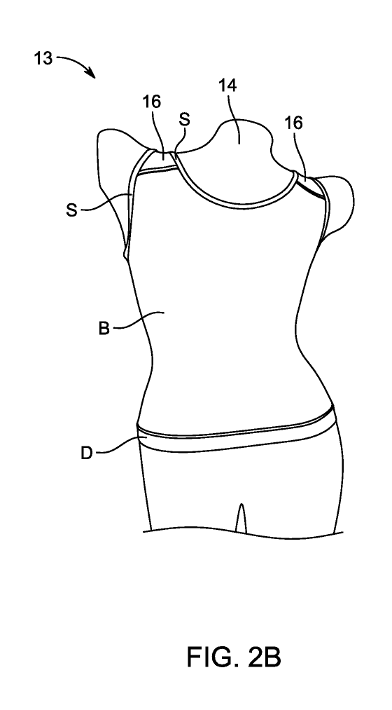

When composite material 10 is incorporated in a garment that is worn by a user, such as further described below with reference to FIGS. 2A-13D, inner layer 12 of composite material 10 is adjacent to the body of the user such that perspiration (sweat) from the user's skin and skin contact products, such as oil/water based body creams and gels, applied to the user's skin are not absorbed by inner layer 12 and, therefore, are prevented by inner layer 12 from being transmitted to outer layer 11. Stated otherwise, inner layer 12 is sufficiently resistant to, and thereby does not absorb skin perspiration and skin contact products, thereby effectively isolating these products from outer layer 11 and preventing them from reaching outer layer 11. Inner layer 12 of composite material 10 therefore constitutes means for isolating skin perspiration and skin products in contact with the user's skin from outer layer 11.

In one embodiment of composite material 10, outer layer 11 is fabricated from a blend of polyester and spandex, and inner layer 12 comprises a coating of polyurethane (PU) containing nano-titanium dioxide (nano-TiO₂). In one particular example of this embodiment, outer layer 11 is a material fabricated from a blend of about 90% to 99% polyester and about 1% to 10% spandex, and inner layer 12 contains about 99% to 99.9% PU and about 0.1% to 1% nano-TiO₂.

The nano-TiO₂ makes inner layer 12 of composite material 10 more elastic, water repellent and oil resistant, and preserves the color of inner layer 12 for a longer period of time. Additionally, the nano-TiO₂ makes inner layer 12 more acid and alkali resistant so that when composite material 10 is incorporated in a garment, inner layer 12 is able to cope with the different nature and characteristics of oil/water based creams and other similar products in contact with the skin of the user wearing the garment. The PU increases the compression of the spandex material.

The coating of PU and nano-TiO₂ can be applied to the fabric base utilizing any technique known in the art. For example, the coating can be applied to the fabric base utilizing known dip coating or spray coating techniques.

According to a feature of the present invention, when incorporated in a garment as shown in FIGS. 2A-13D, for example, composite material 10 can be provided in the form of specially designed cuts, and different levels of compression can be achieved by adjusting the compression of outer layer 11 in the cuts to serve different compression needs of different body parts of the wearer. The high compression and high elasticity of outer layer 11 together with the specially designed cuts of composite material 10 forming the garment function to redistribute the body mass of the wearer and create a new body silhouette.

Another aspect of the present invention is directed to garments, such as sportswear and shapewear garments, made using composite material 10 according to the present invention. In an exemplary embodiment described in more detail below, the garment is a shapewear garment formed of a plurality of panels configured to provide targeted levels of compression and elasticity to firm up various parts of the wearer's body (torso), such as to flatten the abdomen, cinch the waist, create a smoother and tighter backline, and provide women's breasts with firm and comfortable support. In another exemplary embodiment described in more detail below, the garment is not formed with the plurality of panels.

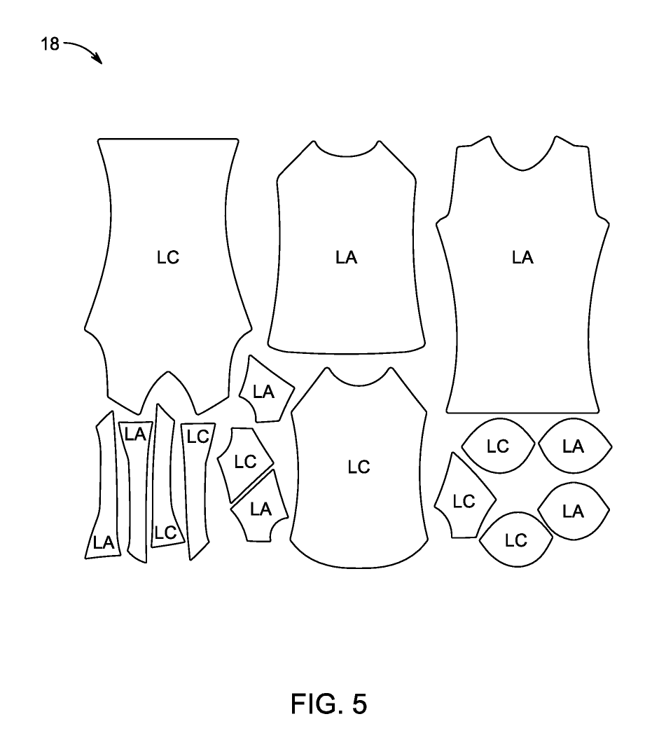

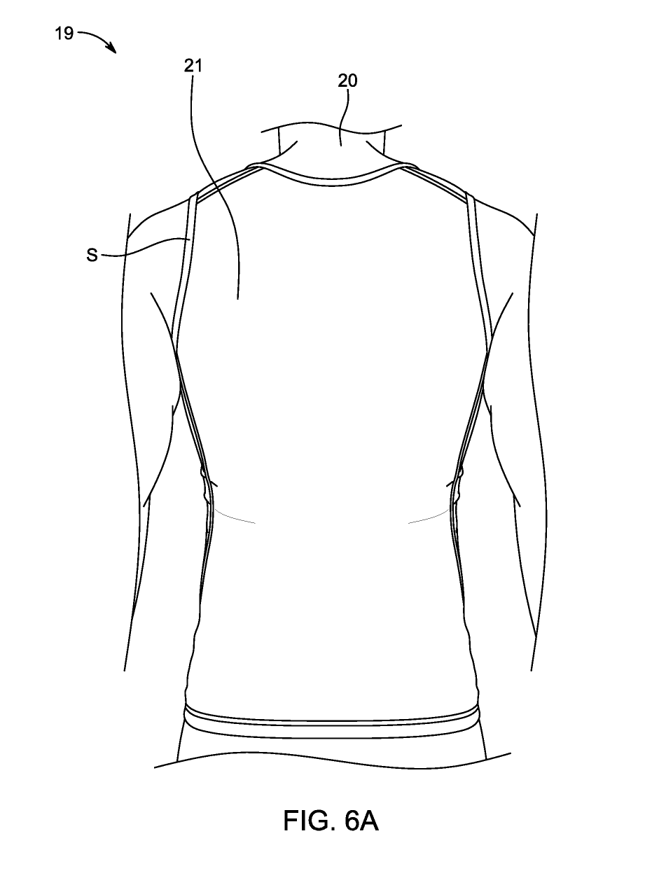

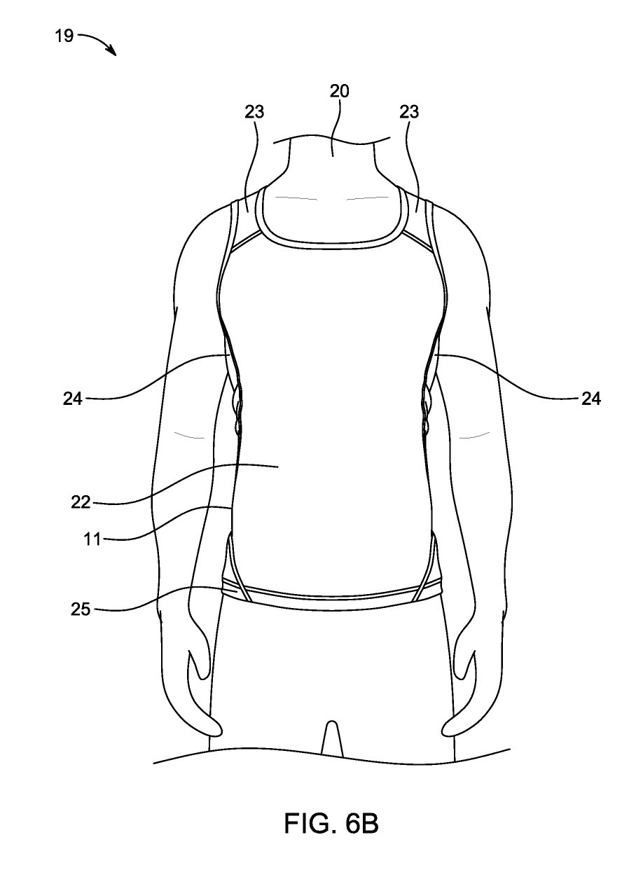

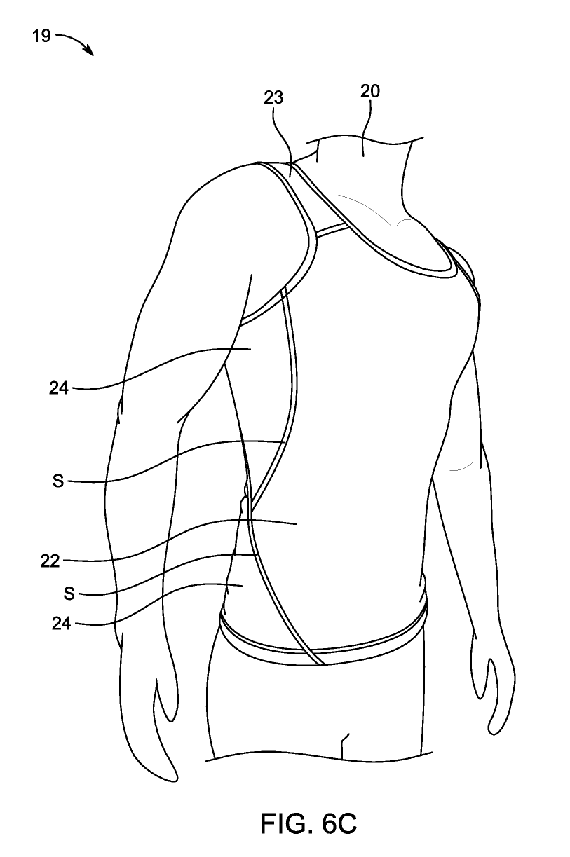

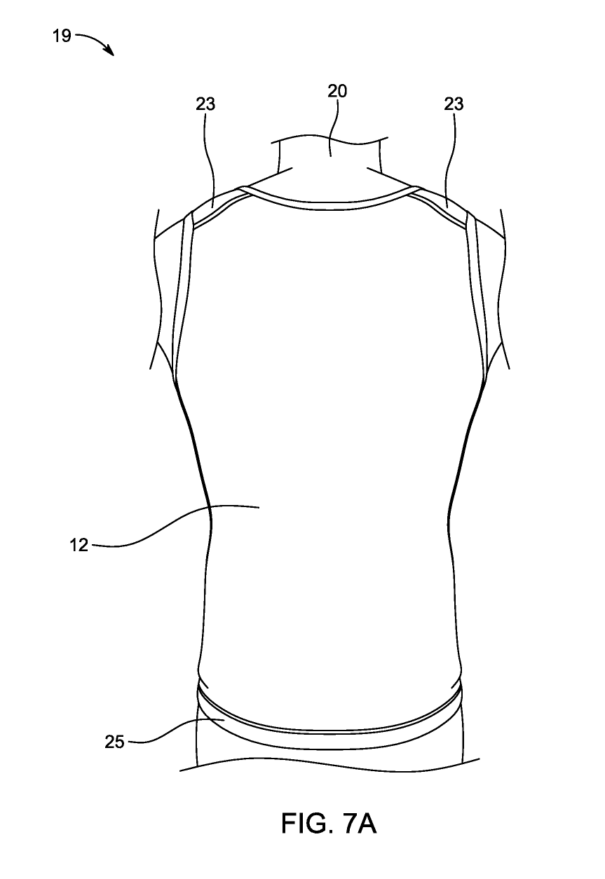

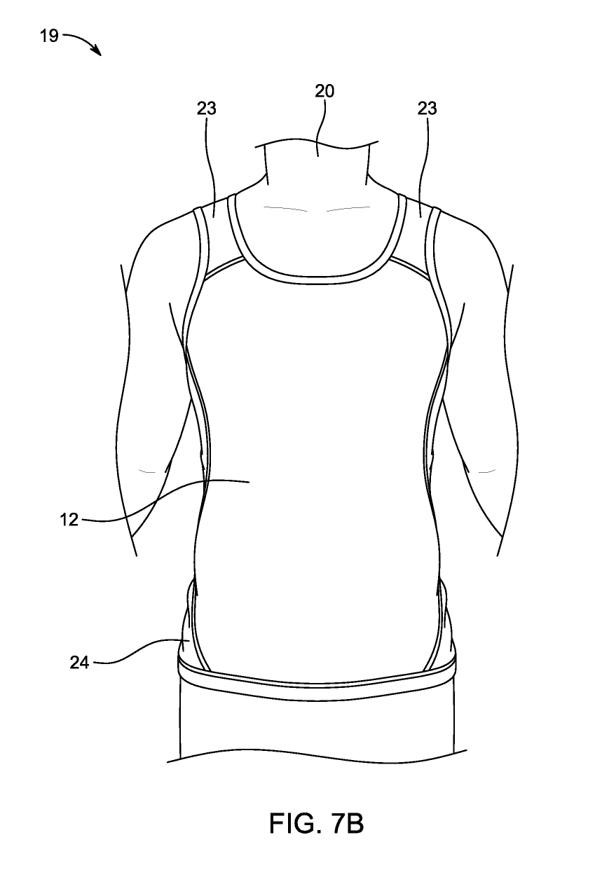

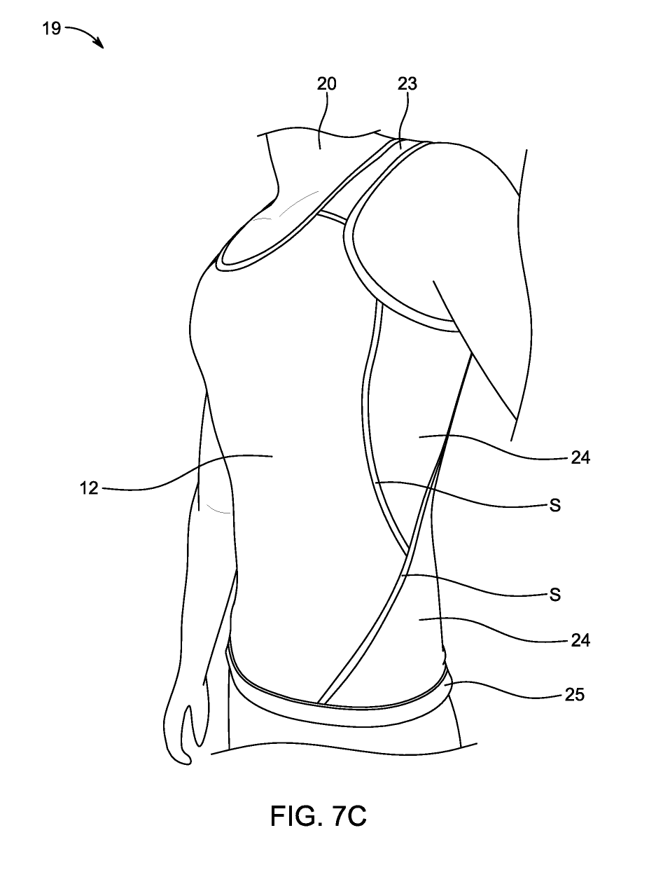

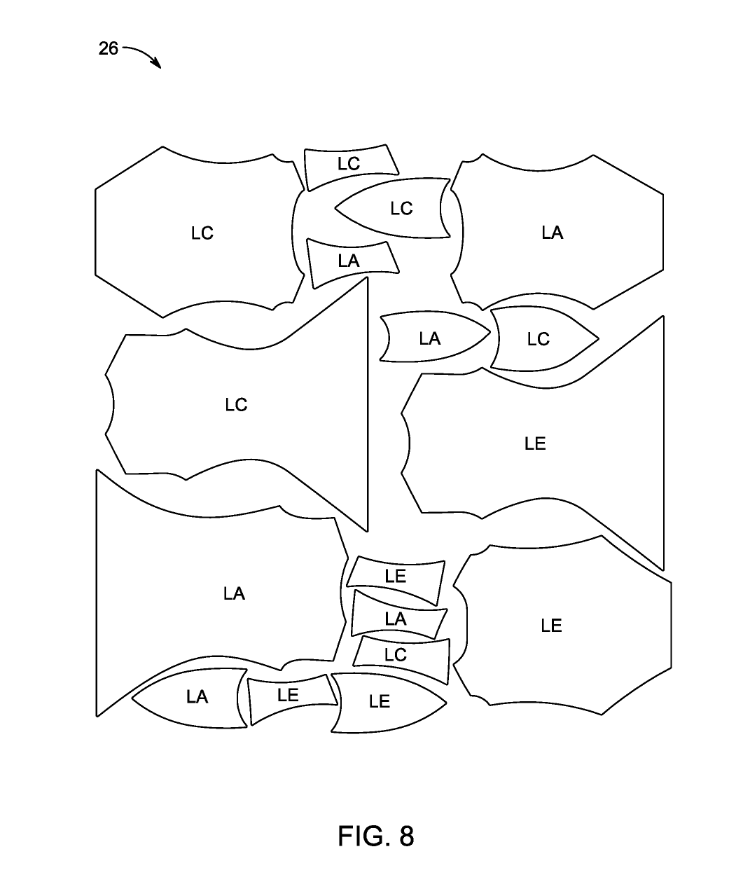

FIGS. 2A-8 illustrate embodiments of shapewear garments (hereinafter also “shapers” or “shaper”) made using composite material 10. FIGS. 2A-4B show a shapewear garment designed for women, and FIGS. 6A-7C show a shapewear garment designed for men. FIGS. 5 and 8 show the separate pieces forming the shapewear garments shown in FIGS. 2A-4B and FIGS. 6A-7C, respectively, illustrating the designs or patterns thereof.

Referring to FIGS. 2A-4B, the shaper, generally designated at 13, is applied on a ¾ armless and headless female mannequin 14, representative of a user of shaper 13, for the purpose of illustrating the various features of the shaper according to the present invention. It is therefore understood that mannequin 14 does not form part of the invention for the embodiments described herein with reference to FIGS. 2A-13D.

Shaper 13 is formed of several parts or panels A-D and 15-17 configured and assembled together (e.g., by sewing) along seams S to provide targeted compression to and firm up the wearer's torso to reform the body shape and create a tighter, smoother and curvier silhouette.

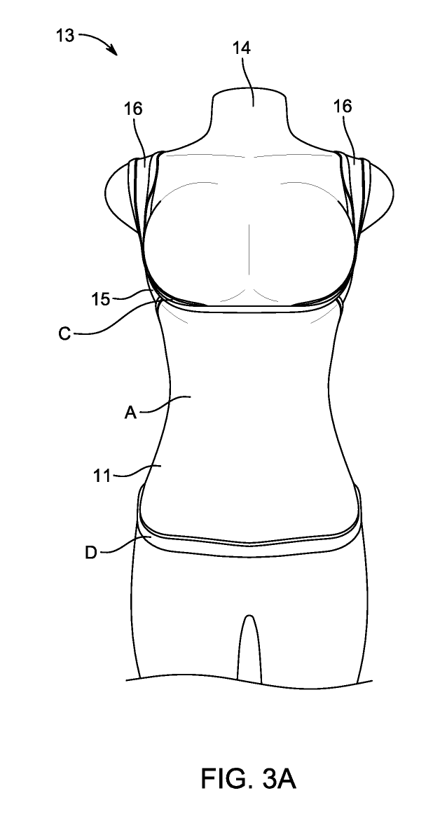

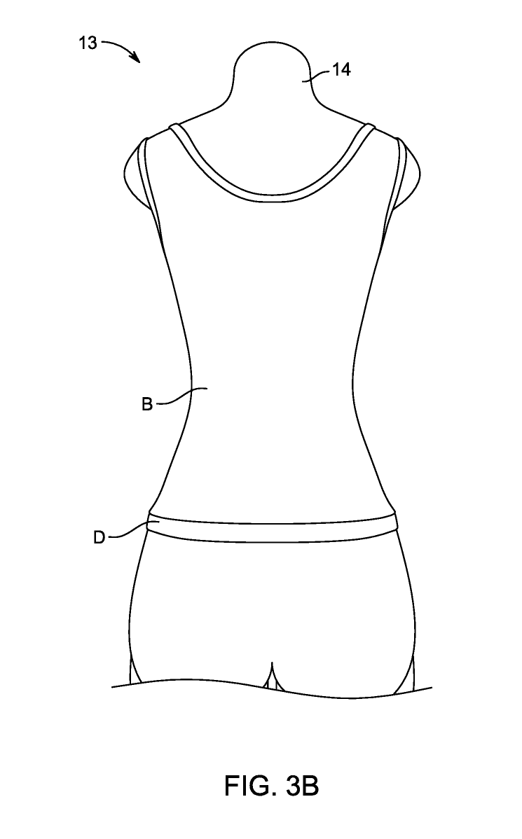

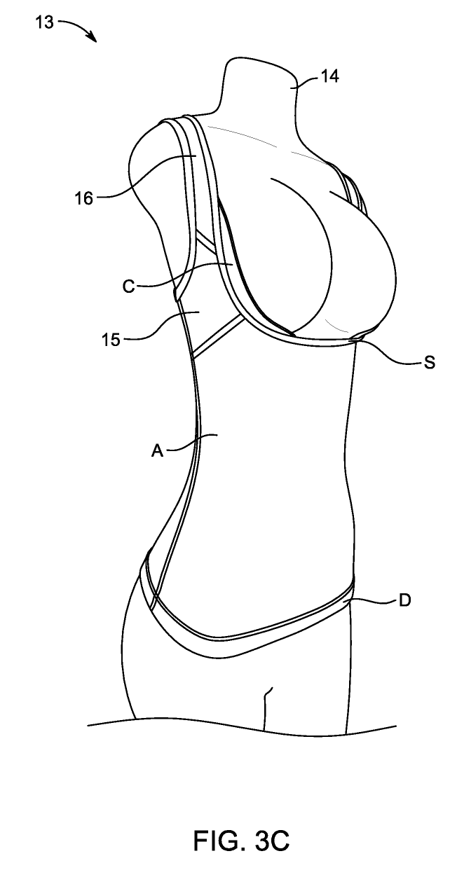

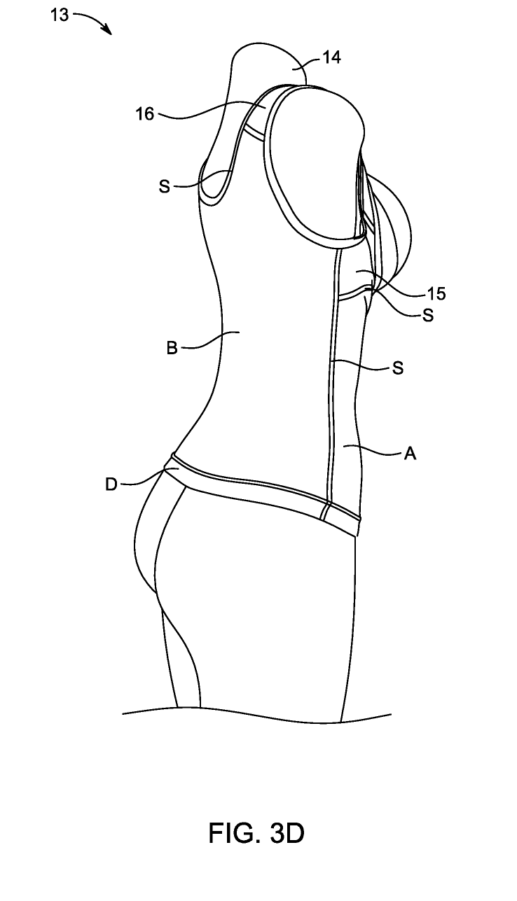

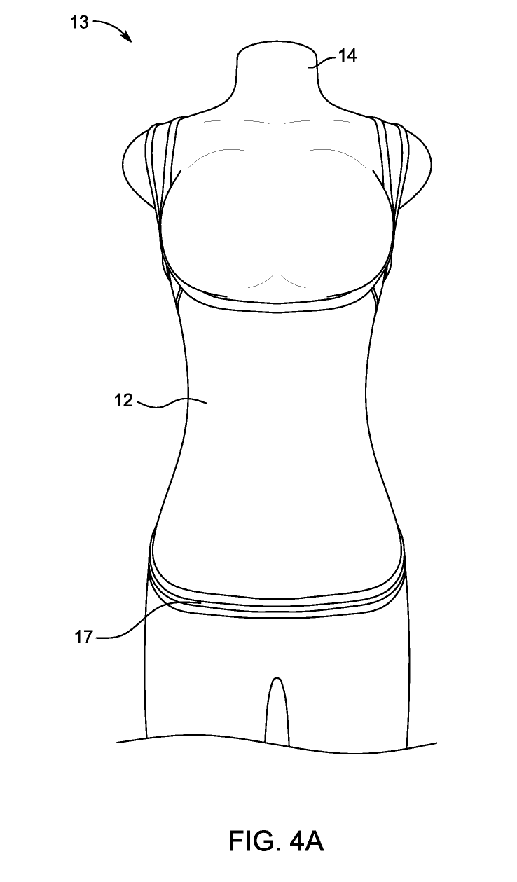

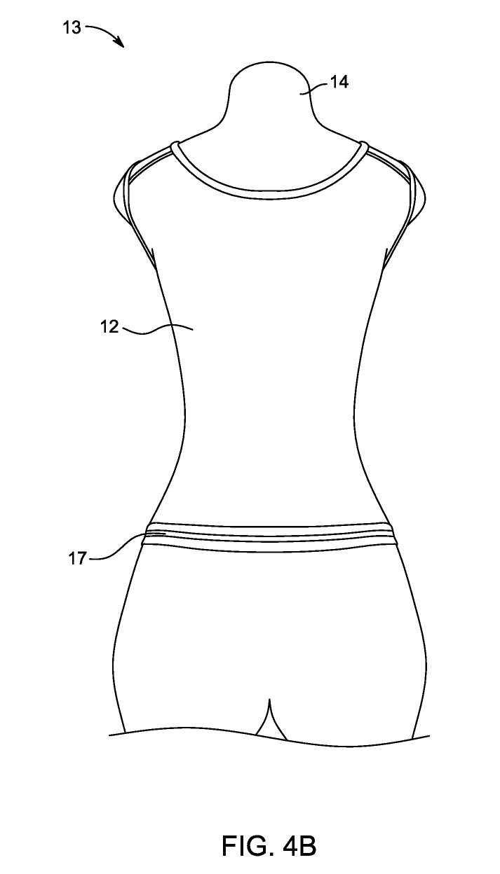

Parts A and B correspond to front and rear sides, respectively, of shaper 13. Parts A and B are interconnected together by top side parts 15 and strap parts 16 which are in turn connected together. Parts C are connected to portions of Part A, top side parts 15 and strap parts 16 and are configured to be positioned in a region below the user's breasts when shaper 13 is worn by the user. Part D is an elastic band with a silicon strip 17 on an inner side thereof (FIGS. 4A-4B). As shown in FIGS. 3A and 3C, portions of shaper 13 defined by part A, parts C, top side parts 15 and strap parts 16 are shaped to support undersides of the breasts of the wearer while leaving the breasts exposed.

The different parts forming shaper 13 have different compression and elasticity levels in order to satisfy the different needs of the different body parts of the user. In an exemplary embodiment, parts A and B have different elastic levels. For example, part A is less elastic in order to flatten the abdomen (tummy) and cinch the waist of the user.

Part B is more elastic in order to create a smoother, tighter backline without over squeezing the flesh and making unwanted flesh tires and while making it easier for the user to put on and take off shaper 13. In the exemplary embodiment, part A has 100% elasticity and part B has 170% elasticity.

In the exemplary embodiment, parts C are soft and only slightly elastic to provide firm and comfortable support to the user's breasts. Silicon strip 17 on the inner side of the elastic band forming part D provides more friction between the shaper 13 and the user's body, including clothing worn underneath shaper 13, thereby functioning to maintain shaper 13 always in place, such as during daily activities (e.g., while exercising).

Parts A and B, top side parts 15 and strap parts 16 of shaper 13 are formed using composite material 10 described above with reference to FIG. 1, including outer layer 11 as a fabric base, and inner layer 12 provided on outer layer 11 and made of a material that is elastic, waterproof and oil proof, thereby making these parts of shaper 13 impervious to water, including skin perspiration, and to oil/water based body creams and gels and similar products that are applied on the user's skin.

FIGS. 2A-3D illustrate the manner in which shaper 13 is worn by the user, with inner layer 12 of composite material 10 positioned adjacent to the user's body. That is, when shaper 13 is worn by the user, inner layer 12 is disposed between outer layer 11 and the user's body. FIGS. 4A-4B are views similar to FIGS. 3A-3B, respectively, except that shaper 13 is applied on mannequin 14 in an inverted state (i.e., outer layer 11 is positioned adjacent to the user's body) only for the purpose of illustrating inner layer 12 of composite material 10 in shaper 13.

In an exemplary embodiment of composite material 10 for parts A, B, top side parts 15 and strap parts 16 of shaper 13, outer layer 11 is fabricated from a blend of polyester and spandex, and inner layer 12 comprises a coating of polyurethane (PU) containing nano-titanium dioxide (nano-TiO₂). In one example of this embodiment, outer layer 11 is a material fabricated from a blend of about 90% to 99% polyester and about 1% to 10% spandex, and inner layer 12 contains about 99% to 99.9% PU and about 0.1% to 1% nano-TiO₂. Each of parts C and the elastic band forming part D of shaper 13 is fabricated from a blend of polyester and spandex. For example, each part C is a material fabricated from a blend of about 90% to 99% polyester and about 1% to 10% spandex, and the elastic band is a material fabricated from a blend of about 80% polyester and 20% spandex. Silicon strip 17 provided on the elastic band can be any type of silicon gripper tape known in the art.

As described above, shaper 13 is configured to be worn by a user so that inner layer 12 of composite material 10 forming shaper 13 is adjacent to the user's body. By this arrangement, perspiration (sweat) from the user's skin and skin contact products, such as oil/water based body creams and gels, applied to the user's skin are not absorbed by inner layer 12 and are effectively prevented by inner layer 12 from being transmitted to outer layer 11. Inner layer 12 is sufficiently resistant to, and thereby does not absorb skin perspiration and skin contact products so as to effectively isolate them from outer layer 11 and prevent them from reaching outer layer 11. Inner layer 12 of composite material 10 therefore constitutes means for isolating skin perspiration and skin products in contact with the user's skin from outer layer 11.

By the foregoing arrangement, including composite material 10, shaper 13 traps body heat under shaper 13 to promote the user to sweat. Specifically, shaper 13 creates a well-sealed space around the user's torso forming a microenvironment between shaper 13 and the user's body that induces perspiration. The microenvironment captures body heat and slows down the heat vitalization, thereby inducing the user's body to sweat more. Specifically, shaper 13 conserves body heat by sealing the body heat in and increases the core temperature, thereby making the user sweat more while performing physical activity, such as during a workout. By inducing perspiration as set forth above, shaper 13 promotes weight loss.

The parts of shaper 13 formed of composite material 10, including parts A-B, top side parts 15 and strap parts 16 are waterproof and oil proof, and serve as an insulation between the body of the user and outwear worn by the user. They can also effectively keep water- and oil-based creams and related products in direct contact with the user's body. The heat generated by the user's body helps open the pores on the user's skin, thereby helping the body to absorb the creams and related products faster.

In view of the foregoing effects produced by shaper 13 on the user's body, treatments applied by water- and oil-based creams and related products in direct contact with the user's body are more effective in that they are able to remain active for long periods of time.

The nano-TiO₂ makes inner layer 12 of composite material 10 more elastic, water repellent and oil resistant, and preserves the color of inner layer 12 for a longer period of time. Additionally, the nano-TiO₂ makes inner layer 12 more acid and alkali resistant which allows inner layer 12 to cope with the different nature and characteristics of oil/water based creams and other similar products in contact with the body of the user wearing shaper 13. Furthermore, the PU increases the compression of the spandex material in outer layer 11.

FIG. 5 is a plan view of the separate pieces, generally designated at 18, including design or pattern thereof, corresponding to the various parts of shaper 13 shown in FIGS. 1-4B, including parts A-C, top side parts 15 and strap parts 16. In FIG. 5, LA, LC designate portions corresponding to outer layer 11 and inner layer 12 of composite material 10.

FIGS. 6A-7C show a shaper, generally designated at 19, designed for men. Shaper 19 is shown being worn on the body 20 of a user. Shaper 19 is formed of several parts or panels 21-25 configured and assembled together (e.g., by sewing) along seams S to provide targeted compression to and firm up the wearer's torso to reform the body shape and create a tighter, smoother and curvier silhouette. Parts 21 and 22 of shaper 19 are configured for resting on the back and front sides, respectively, of user's body 20. Parts 21 and 22 are connected together by parts 23-24 configured for resting on shoulder (strap parts 23) and sides (parts 24) of user's body 20. Part 25 is an elastic band similar to the elastic band corresponding to part D described above for the embodiment shown in FIGS. 2A-4B.

As described above for shaper 13, the various parts forming shaper 19 have different compression and elasticity levels in order to satisfy the different needs of the different body parts of the user. For example, part 21 is more elasticity than part 22. Parts 21-24 of shaper 19 are also formed using composite material 10 described above with reference to FIG. 1, including outer layer 11 as a fabric base, and inner layer 12 provided on outer layer 11 and made of a material that is elastic, waterproof and oil proof, thereby making these parts of shaper 19 impervious to water, including skin perspiration, and to oil/water based body creams and gels and similar products that are applied on the user's skin. It is appreciated, however, that shaper 19 can be formed using composite material 10 and without the panels described above.

FIGS. 6A-6C illustrate the manner in which shaper 19 is worn by the user, with inner layer 12 of composite material 10 positioned adjacent to user's body 20. FIGS. 7A-7C show shaper 19 being applied on user's body 20 in an inverted state (i.e., outer layer 11 is positioned adjacent to the user's body) primarily for the purpose of illustrating inner layer 12 of composite material 10 in shaper 19.

The construction, including materials and arrangements, as well as the advantages and benefits of composite material 10 for parts 21-24 and of materials for elastic band 25 of shaper 19 are as described above for composite material 10 and the elastic band of shaper 13 with reference to FIGS. 1-5. This includes the advantageous effects of the PU and nano-TiO₂ in inner layer 12 as described above for shaper 13.

As described above, shaper 19 is configured to be worn by a user so that inner layer 12 of composite material 10 forming shaper 19 is adjacent to user's body 20. By this arrangement, perspiration (sweat) from the user's skin and skin contact products, such as oil/water based body creams and gels, applied to the user's skin are not absorbed by inner layer 12 and are effectively prevented by inner layer 12 from being transmitted to outer layer 11. Inner layer 12 is sufficiently resistant to, and thereby does not absorb skin perspiration and skin contact products so as to effectively isolate them from outer layer 11 and prevent them from reaching outer layer 11. Inner layer 12 of composite material 10 therefore constitutes means for isolating skin perspiration and skin products in contact with the user's skin from outer layer 11.

Similar to shaper 13, the arrangement and construction of shaper 19, including composite material 10, promotes the user to sweat by trapping body heat under shaper 19. Specifically, shaper 19 creates a well-sealed space around the user's torso forming a microenvironment between shaper 19 and the user's body that induces perspiration. The microenvironment captures body heat and slows down the heat vitalization, thereby inducing the user's body to sweat more. Specifically, shaper 19 conserves body heat by sealing the body heat in and increases the core temperature, thereby making the user sweat more while performing physical activity, such as during a workout. By inducing perspiration as set forth above, shaper 19 promotes weight loss.

By the characteristics of inner layer 12 as described above, the parts of shaper 19 formed of composite material 10, including parts 21-24 are waterproof and oil proof, and serve as insulation between the body of the user and outwear worn by the user. They can also effectively keep water- and oil-based creams and related products in direct contact with user's body 20. The heat generated by user's body 20 helps open the pores on the user's skin, thereby helping the body to absorb the creams and related products faster. In view of the foregoing effects produced by shaper 19 on the user's body, treatments applied by water- and oil-based creams and related products in direct contact with the user's body are more effective in that they are able to remain active for long periods of time.

FIG. 8 is a plan view of the separate pieces, including design or pattern thereof (generally designated at 26), corresponding to the various parts of shaper 19 shown in FIGS. 6A-7C, including parts 21-24. In FIG. 8, LA, LC and LE designated portions of outer layer 11 and inner layer 12 of composite material 10.

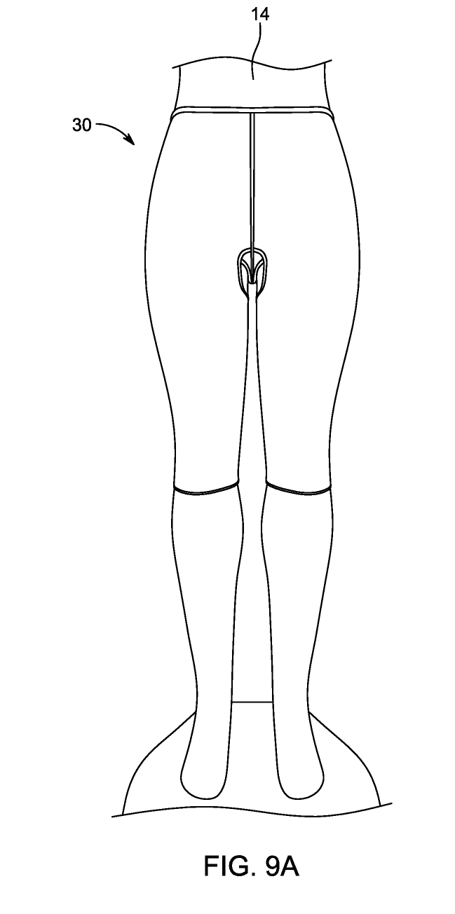

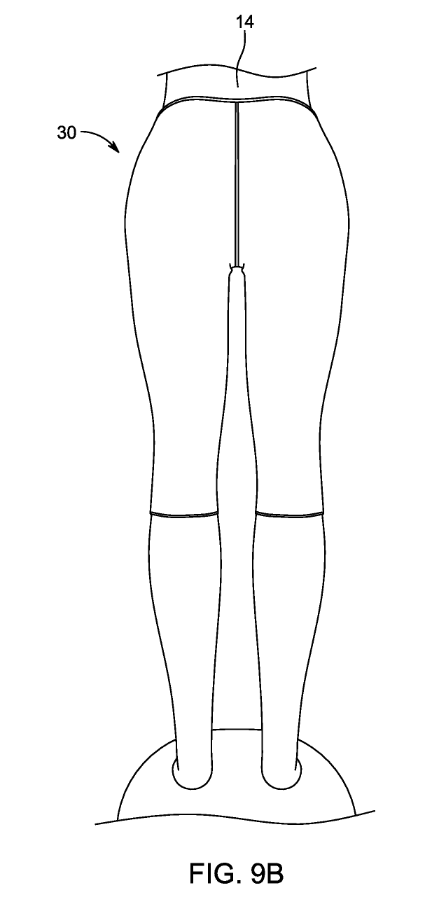

FIGS. 9A-9B are front and rear views of an exemplary embodiment of another shapewear garment, generally designated at 30, employing the composite material 10 according to the present invention, the garment being applied on a mannequin 14 to illustrate the garment in use with respect to the wearer's body. Garment 30 is in the form of a knee length pant garment configured for use by women.

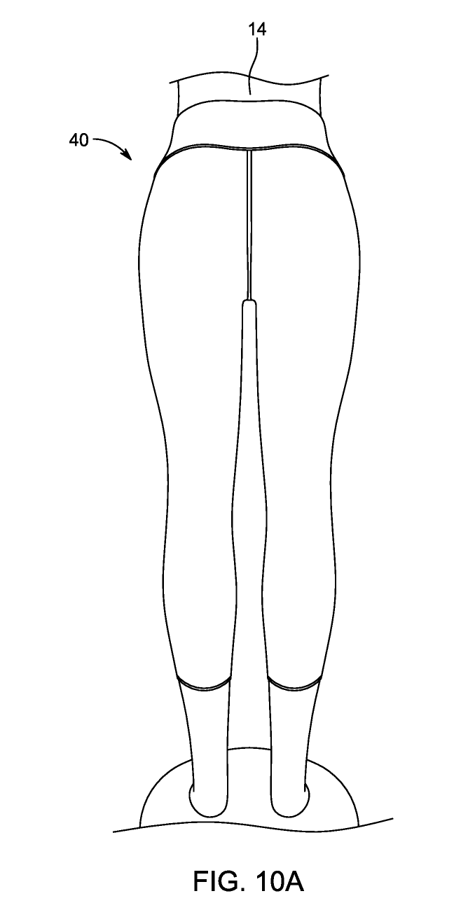

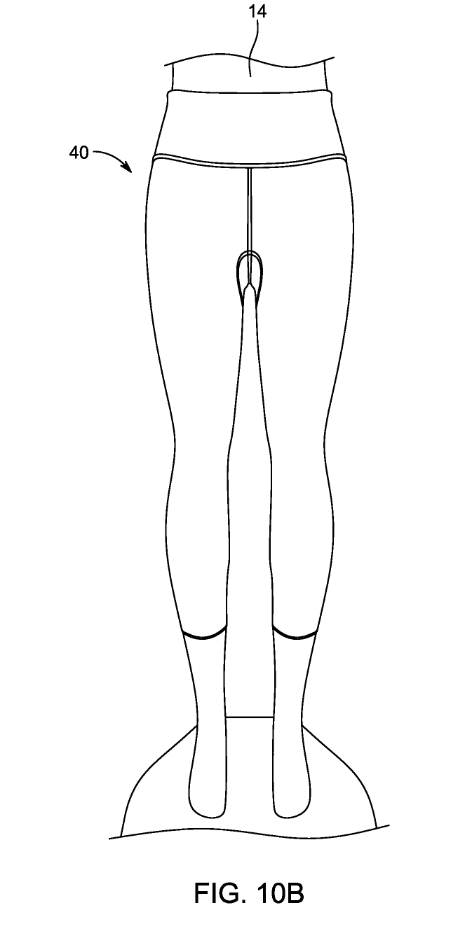

FIGS. 10A-10B are rear and front views of an exemplary embodiment of another shapewear garment, generally designated at 40, employing the composite material 10 according to the present invention, the garment being applied on a mannequin 14 to illustrate the garment in use with respect to the wearer's body. Garment 40 is in the form of a calf length pant garment configured for use by women.

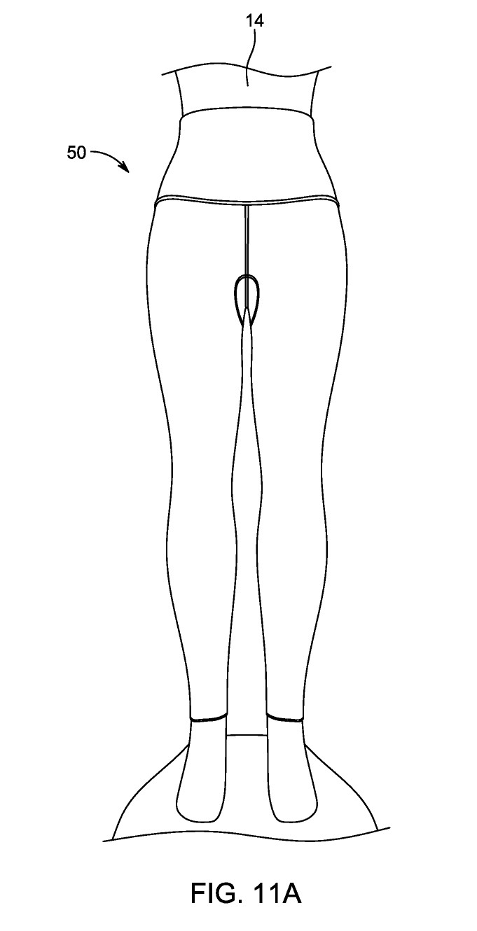

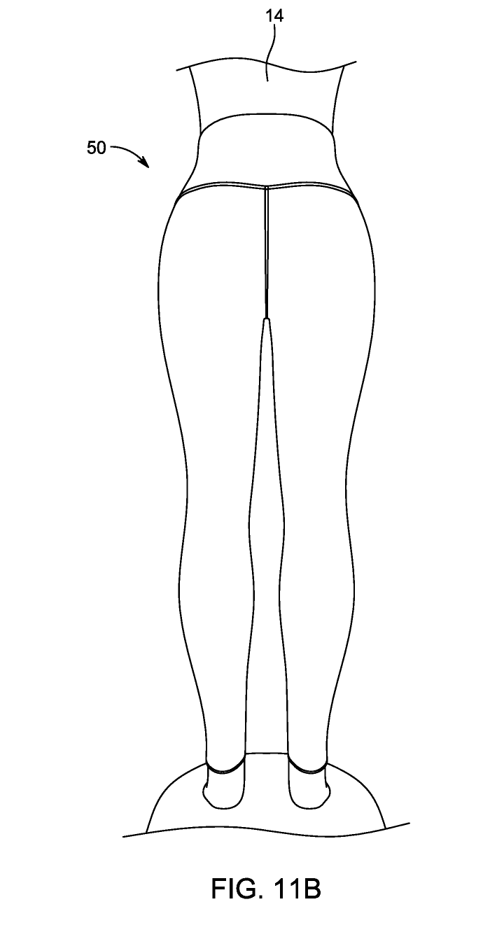

FIGS. 11A-11B are front and rear views of an exemplary embodiment of another shapewear garment, generally designated at 50, employing the composite material 10 according to the present invention, the garment being applied on a mannequin 14 to illustrate the garment in use with respect to the wearer's body. Garment 50 is in the form of a full length pant garment configured for use by women.

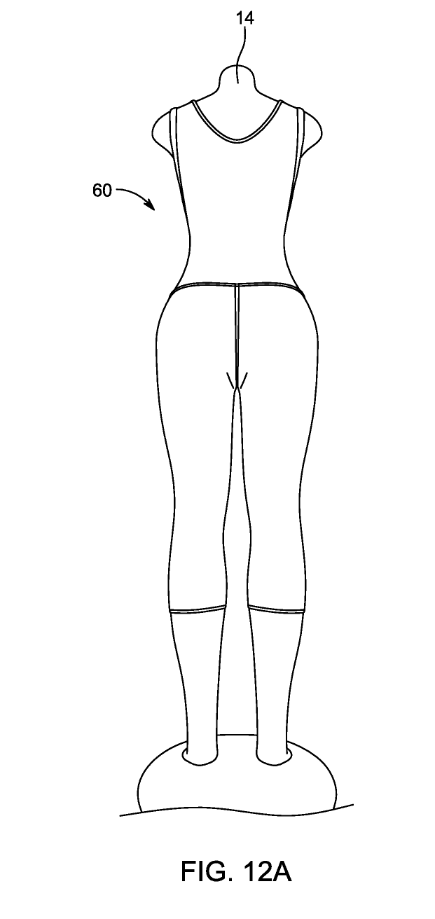

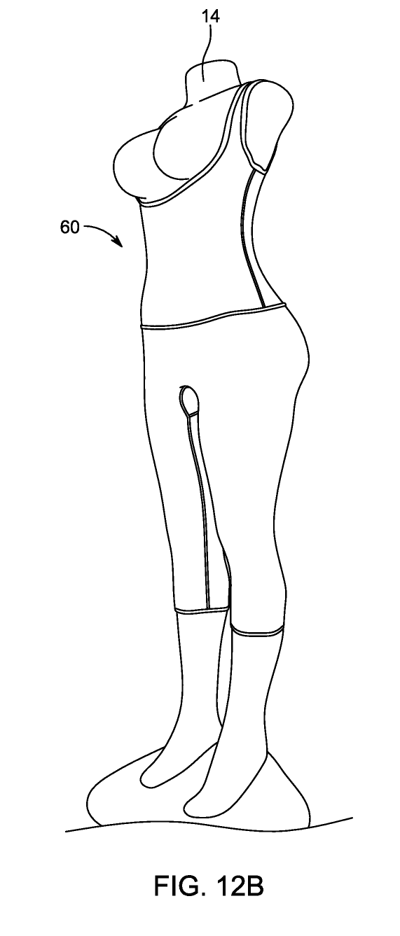

FIGS. 12A-12B are rear and side perspective views of an exemplary embodiment of another shapewear garment, generally designated at 60, employing the composite material 10 according to the present invention, the garment being applied on a mannequin 14 to illustrate the garment in use with respect to the wearer's body. Garment 60 is in the form of a full body garment with a calf length pant portion configured for use by women.

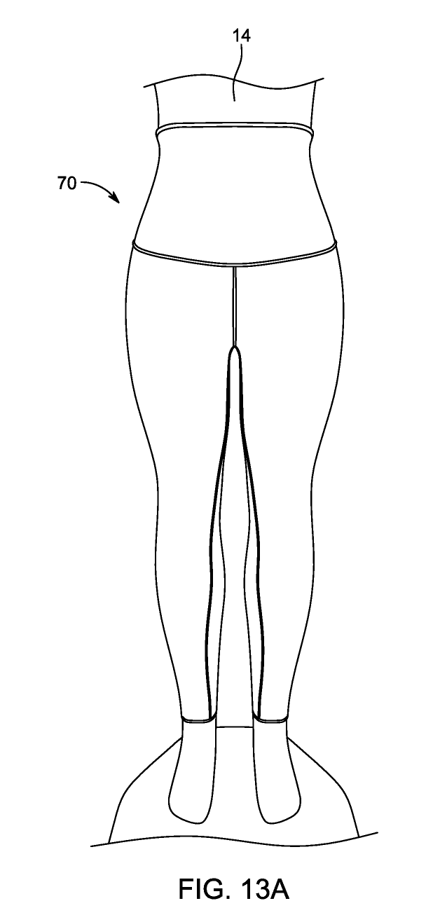

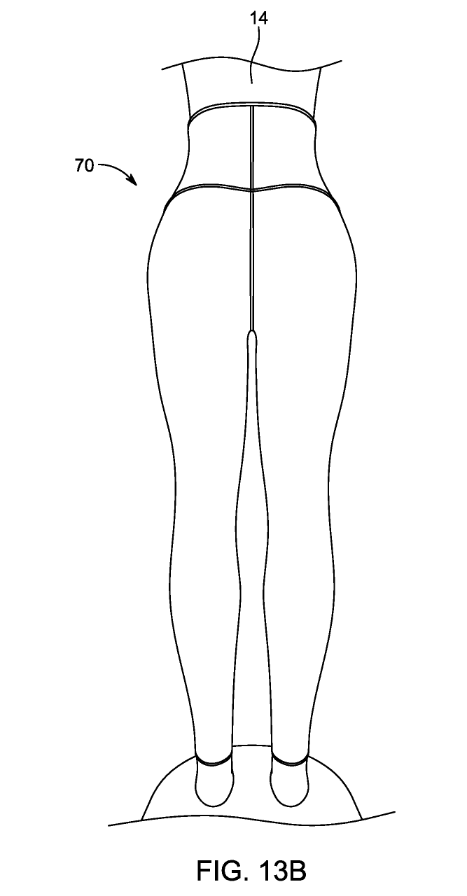

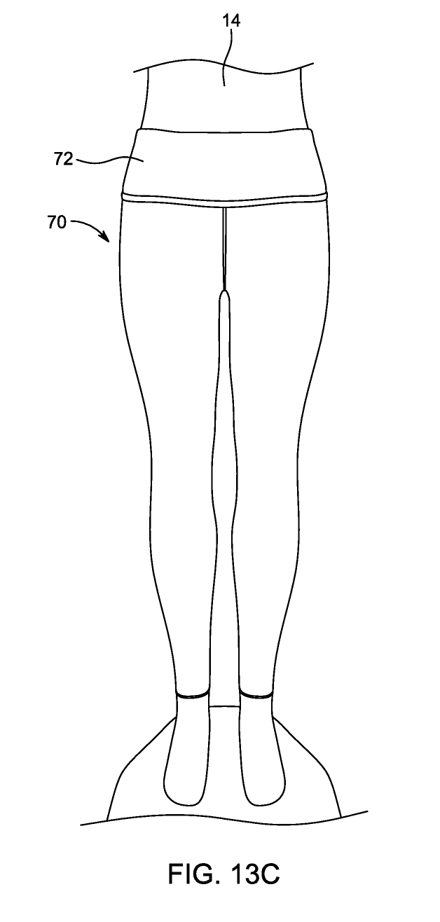

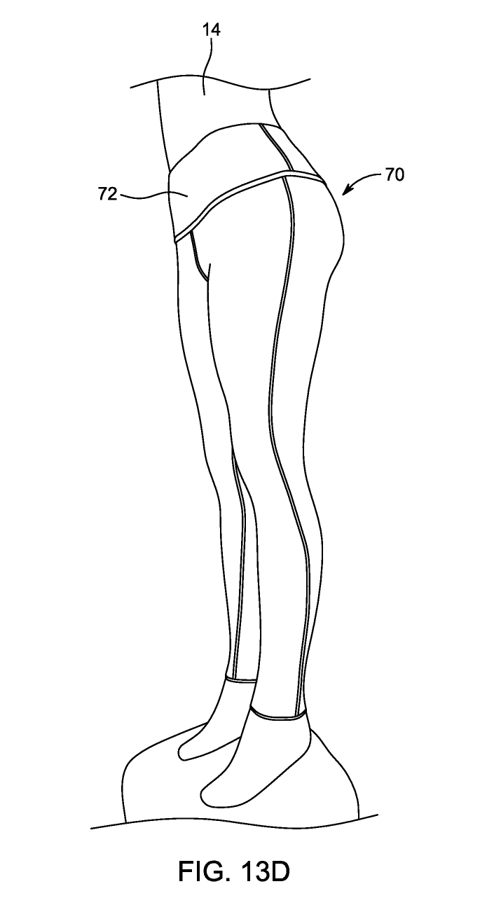

FIGS. 13A-13D are front, rear and side perspective views of an exemplary embodiment of another shapewear garment, generally designated at 70, employing the composite material 10 according to the present invention, the garment being applied on a mannequin 14 to illustrate the garment in use with respect to the wearer's body. Garment 70 is in the form of a high waist, full length pant garment configured for use by women. FIGS. 13C-13D further illustrate a waist portion of the garment being folded over to show inner layer 72 of the composite material.

Garments 30, 40, 50, 60 and 70 shown in FIGS. 9A-13D employ the composite material 10, including inner and our layers, as described above for the embodiments of the garments shown in FIGS. 2A-8. However, garments 30, 40, 50, 60 and 70 are not formed of a plurality of panels configured to provide targeted levels of compression and elasticity as described above for the garments shown in FIGS. 2A-8. It can be appreciated, however, that garments 30, 40, 50, 60 and 70 may be formed of such plurality of panels without departing from the spirit and scope of the invention. Likewise, while garments 30, 40, 50, 60 and 70 are configured for use by women, it will be appreciated that the composite material according to the present invention is also suitable for use with garments (e.g., with or without the plurality of panels as described above) configured for use by men.

The garments described according to the foregoing embodiments of the present invention are functional and comfortable, and are discreet in that from the outside they look just like an everyday outwear. Accordingly, the garments of the present invention are suitable for wearing during many public occasions.

It is to be understood that the garments according to the present invention described herein with reference to the drawings are only some of many possible embodiments of the types of garments in which composite material 10 in accordance with the present invention may be used. Composite material 10 may also be used to fabricate other articles of apparel, such as various other types and designs of sportswear garments.

The garments made of the composite material described herein according to the present invention are configured to keep users comfortable, are strong, durable, light-weight and without undue bulk, and may be manufactured at low cost.

The garments employing the composite material according to the present invention are easy to apply and do not generate marks on the wearer's skin. While easy to put on and take off, the garments according to the present invention apply sufficient compression to the wearer's body to achieve significant changes to the form of the wearer's body in order to produce a more fashionable slim figure and to significantly enhance the natural curves of the wearer's body.

When worn by a user, the arrangement and construction of the shapewear garment formed of the composite material according to the present invention creates a well-sealed space around the user's torso forming a microenvironment between the shapewear garment and the user's body that induces perspiration. The microenvironment captures body heat and slows down the heat vitalization, thereby inducing the user's body to sweat more. Specifically, the shapewear garment conserves body heat by sealing the body heat in and increases the core temperature, thereby making the user sweat more while performing physical activity, such as during a workout, and resulting in a significant loss of body mass over time.

While providing a body shaping function, the garments according to the present invention directly contribute to the user's actual weight loss or other daily fitness purpose. The garments according to the present invention can also be used in combination with gel/oil/water based creams and other skin contact products which are applied directly to and absorbed by the user's skin for various purposes, including weight-loss, cellulite-elimination, moisturization and skin detoxification. As a result of the composite material described above according to the present invention, the skin contact products are not absorbed by the fabric material (fabric base) portion of the composite material forming the garment, thereby increasing the amount of the skin contact product to be absorbed by the user's body.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but are to be accorded the widest scope consistent with the principles and novel features disclosed herein.

What is claimed is:

1. A garment having an internal surface adapted to contact a wearer's skin and an external surface, the garment comprising: a fabric base having opposite surfaces including a surface defining the external surface of the garment, the fabric base being made of a blend of polyester and spandex; and a coating of polyurethane (PU) containing nano-titanium dioxide (nano-TiO₂) provided on the surface of the fabric base opposite the external surface, the coating defining the internal surface of the garment adapted to contact a wearer's skin.

2. The garment of claim 1, wherein the fabric base is made of about 90% to 99% polyester and about 1% to 10% spandex; and wherein the coating contains about 99% to 99.9% PU and about 0.1% to 1% nano-TiO₂.

3. The garment of claim 1, wherein the garment is a shapewear garment.

4. The garment of claim 3, wherein the shapewear garment comprises a plurality of panels connected together and configured to provide targeted levels of compression and elasticity to firm up various parts of the body of a wearer of the garment.

5. The garment of claim 1, wherein the coating is impervious to water and to oil/water based body creams and gels.

6. The garment of claim 1, wherein the fabric base is a blend of about 90% to 99% polyester and about 1% to 10% spandex.

7. The garment of claim 1, wherein the coating contains about 99% to 99.9% PU and about 0.1% to 1% nano-TiO₂.

8. A composite material for items of clothing, comprising: an inner layer, to be directed toward the body of the user, which is waterproof and oil proof, the inner layer being made of polyurethane (PU) containing nano-titanium dioxide (nano-TiO₂); and a fabric base on which the inner layer is disposed, the fabric base being made of a blend of polyester and spandex.

9. The composite material of claim 8, wherein the fabric base is made of about 90% to 99% polyester and about 1% to 10% spandex; and wherein the inner layer is made of about 99% to 99.9% PU and about 0.1% to 1% nano-TiO₂.

10. The composite material of claim 8, wherein the fabric base is a blend of about 90% to 99% polyester and about 1% to 10% spandex.

11. The composite material of claim 8, wherein the coating contains about 99% to 99.9% PU and about 0.1% to 1% nano-TiO₂.

12. A composite material comprising: an outer layer that is highly elastic with high compression; and an inner layer provided on the outer layer and made of a material that is elastic, waterproof and oil proof

13. The composite material of claim 12, wherein the inner layer is impervious to water and to oil/water based body creams and gels.

14. The composite material of claim 13, wherein the outer layer is a fabric base made of a blend of polyester and spandex.

15. The composite material of claim 14, wherein the fabric base is a blend of about 90% to 99% polyester and about 1% to 10% spandex.

16. The composite material of claim 15, wherein the inner layer comprises a coating of polyurethane (PU) containing nano-titanium dioxide (nano-TiO₂).

17. The composite material of claim 16, wherein the inner layer contains about 99% to 99.9% PU and about 0.1% to 1% nano-TiO₂.

18. The composite material of claim 12, wherein the outer layer is a fabric base made of a blend of polyester and spandex; and wherein the inner layer comprises a coating of polyurethane (PU) containing nano-titanium dioxide (nano-TiO₂).

19. The composite material of claim 18, wherein the fabric base is a material fabricated from a blend of about 90% to 99% polyester and about 1% to 10% spandex, and the inner layer contains about 99% to 99.9% PU and about 0.1% to 1% nano-TiO₂.

20. The composite material of claim 19, wherein the inner layer is impervious to water and to oil/water based body creams and gels.
